(19) United States
(12) Patent Application Publication
(10) Pub. No.: US 2010/0083993 A1
(43) Pub. Date: Apr. 8, 2010

(54) ATTACHMENT FOR AMBULATORY ASSIST DEVICE

(75) Inventor: Gerald A. Vanden Brook, Cape Girardeau, MO (US)

Correspondence Address: SENNIGER POWERS LLP, 100 NORTH BROADWAY, 17TH FLOOR, ST LOUIS, MO, 63102, US

(73) Assignee: ORTHOSTANDARD, LLC, Cape Girardeau, MO (US)

(21) Appl. No.: 12/245,380

(22) Filed: Oct. 3, 2008

(51) Int. Cl. A61H 3/00

(52) U.S. Cl. 135/67

(57) ABSTRACT

An attachment adapted for use with a walker including a support member. The support member has a longitudinal axis. A leg engagement portion is located on the support member. An opening in the support member extends transversely with respect to the longitudinal axis.

### FIELD OF THE INVENTION

The present invention generally relates to ambulatory assist devices, and more specifically to a leg rest attachment for an invalid walker.

### BACKGROUND OF THE INVENTION

Walkers are widely used to assist a user during walking. Various attachments have been provided to support the user while the user is in a seated position and while the walker is in use. Such attachments are generally in the form of rigid or pivotable seats and platforms capable of supporting a knee, thigh or entire body of the user.

However, some attachment devices can be cumbersome and require an involved process to secure to the walker. Further, walker configurations vary and some attachment devices do not provide for variations in configuration. Additionally, some of these devices do not provide adequate support for the user over time while also allowing sufficient range of motion during walking. Also, some attachment devices may only be used on one side of walkers requiring manufactures and distributers to make and stock twice as many devices as would be required if the device could be used to selectively support either leg. Therefore, there is a need for an attachment that easily secures to a walker and provides a lasting stable support of both legs, allowing for unimpeded motion by the user.

### SUMMARY OF THE INVENTION

The invention relates generally to an attachment adapted for use with a walker. The attachment comprises a support member having a longitudinal axis. A leg engagement portion is located on the support member. An opening in the support member extends transversely with respect to the longitudinal axis.

In another aspect of the invention, the attachment comprises a support member having first and second ends and a leg engagement portion. Slots are located on the first and second ends of the support member. Hooks are received through the slots and adapted to hook onto the walker. The hooks are capable of sliding along the slots to adjust the position of the hooks in the slots.

In yet another aspect of the invention, a walker comprises first and second front legs, first and second back legs, and first and second braces. The first brace connects the first front leg to the first back leg. The second brace connects the second front leg to the second back leg. The walker further comprises an attachment comprising a support member having a longitudinal axis, first and second ends and a transverse opening. Hooks are associated with the first and second ends. The hooks are engaged with the first and second braces to hold the attachment between the first and second braces.

In yet another aspect of the invention, a walker attachment comprises a support member having opposite top and bottom faces. A leg engagement portion is selectively attachable to the top and bottom faces.

Other objects and features will be in part apparent and in part pointed out hereinafter.

### BRIEF DESCRIPTION OF THE DRAWINGS

FIG. 1 is perspective of an ambulatory assist device with an attachment;

FIG. 2 is a perspective of the attachment;

FIG. 3 is a top view of the attachment;

FIG. 4 is a bottom view of the attachment;

FIG. 5 is a perspective of a cushion of the attachment; and

FIG. 6 is a side view of the cushion.

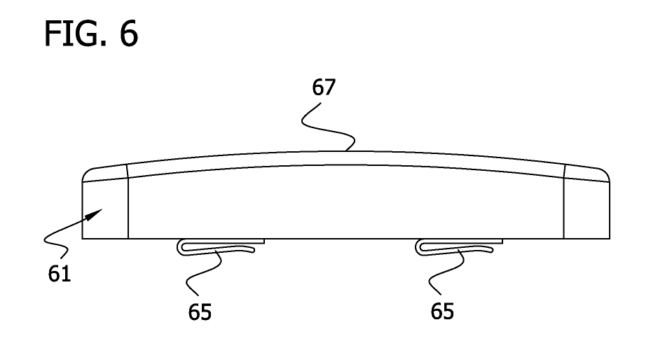

Corresponding reference characters indicate corresponding parts throughout the drawings.

### DESCRIPTION OF THE PREFERRED EMBODIMENTS

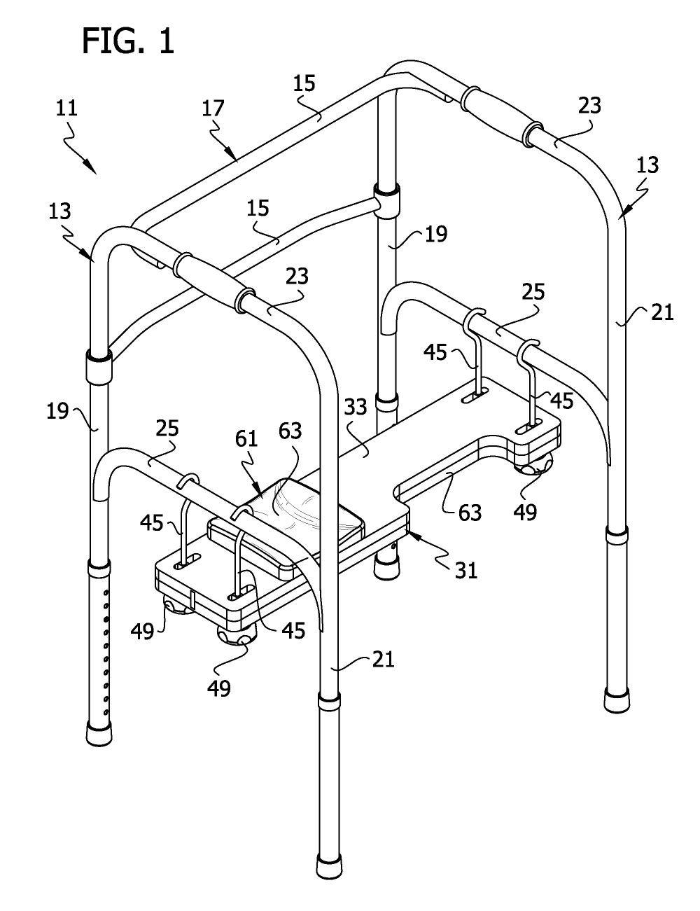

Referring to the drawings and particularly to FIG. 1, an ambulatory assist device or walker 11 includes a pair of inverted U-shaped support frames 13 and a pair of cross bars 15 connecting the support frames at an upper front end 17 of the walker. Each support frame 13 includes a front leg 19 and a back leg 21 connected by a gripping arm 23. A pair of fore-to-aft braces 25 extend between the front legs 19 and the back legs 21, bracing the legs against loading. The terms “front” and “back” are determined from the perspective of a user facing forwardly in the walker 11. Because the walker 11 is conventional, it will not be described in further detail.

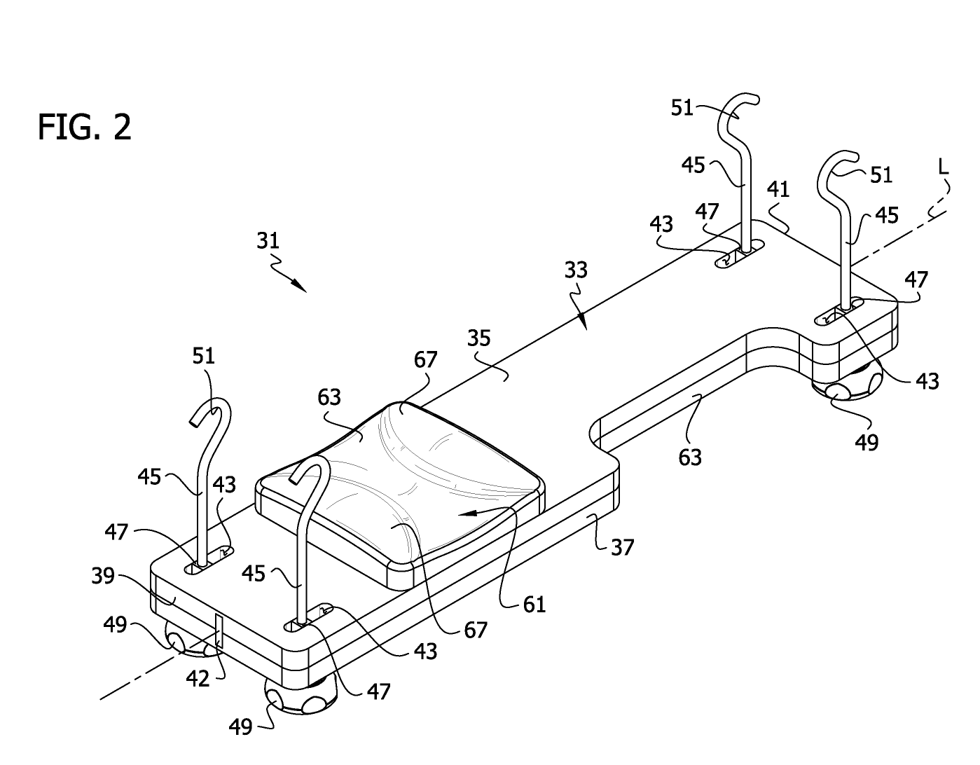

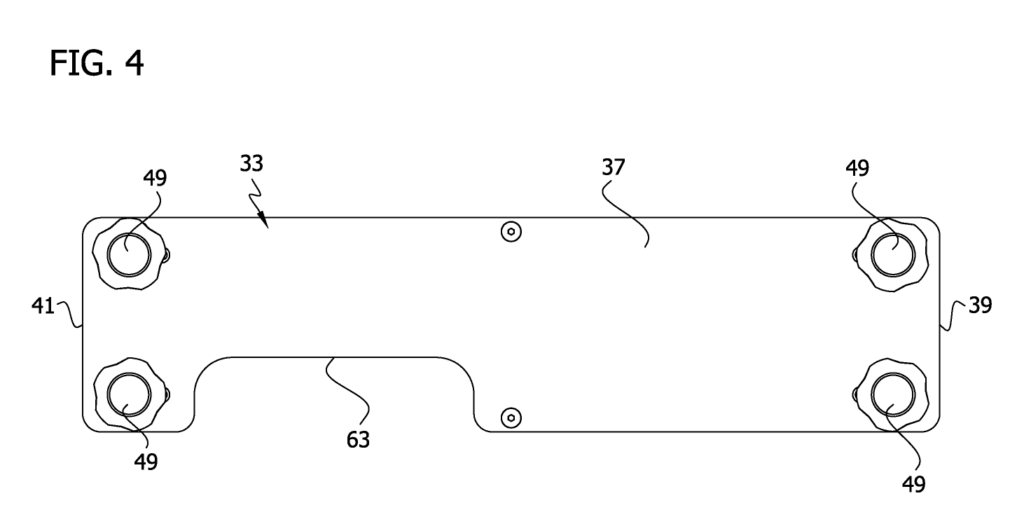

Now referring to FIGS. 2-4, an attachment 31 is engageable with the walker 11. The attachment 31 includes a support member 33 having a longitudinal axis L, top and bottom plates 35, 37 (respectively), and first and second ends 39, 41 (respectively). The plates 35, 37 are fastened together by screws (not shown). A bar 42 is inserted in the center of the plates 35, 37 and extends along the longitudinal axis L. Four slots 43 are located at corners of each end 39, 41 and are sized to receive J-Hooks 45. In one embodiment, the slots 43 are generally longitudinally aligned allowing the attachment to be used with walkers having differing lengths. Nuts 47 are formed in the slots 43 of the support member 33 and are permitted to slide within the slots. An inner diameter of the nuts 47 is sized to receive a shaft of the J-hooks 45 to hold the hooks in place. The slots 43 have a width that is substantially similar to, and a length that is substantially greater than the diameter of the shaft of the J-hooks 45 such that the hooks slide within the slots when the hooks are received in the nuts 47. Fastening knobs 49 are secured over the shaft of the J-hooks 45 to lock the hooks in place. Each J-hook 45 has a sufficiently large opening 51 to receive the braces 25 of the walker 11. This arrangement secures the attachment 31 to the walker 11. Since the J-hooks 45 engage the braces 25, the attachment 31 uses a non-load bearing element of the walker 11 to support the user. As will be appreciated by those skilled in the art, the use of the threaded J-hooks 45 and nuts 47 permit the adjustment of a height of the support member 33 so that the attachment 31 may be used with walkers having different configurations and by different size users. The figures illustrate four hooks 45; however, it is contemplated that fewer or more hooks can be used without departing from the scope of the invention. It is also contemplated that the attachment could be secured to the walker by other means (e.g., pins and slots, etc.). Furthermore, the support member 33 is made of polypropylene; however, other suitable materials for load bearing can be used without departing from the scope of the invention.

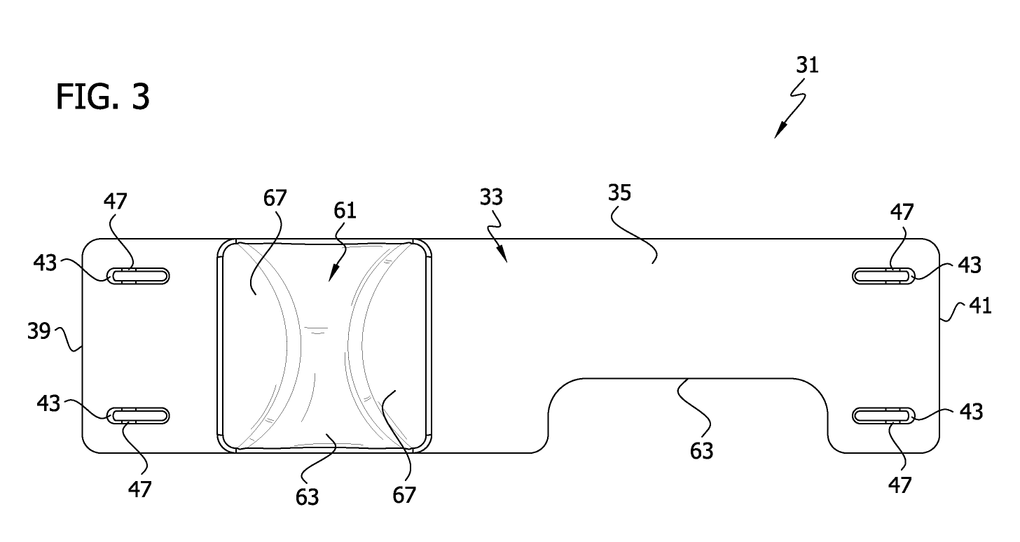

The support member 33 also includes a leg engagement portion 61 positioned near the first end 39 and an opening or transverse recess 63 spaced apart from the leg engagement portion along the length of the support member 33 nearer to the second end 41. The recess 63 is sized and shaped to permit motion of a free leg of the user during a swing phase of gait when the walker 11 is in use. As shown in FIG. 3, the recess 63 has a length of about 8½ inches and a center width of about 3 inches. Other dimensions are acceptable so long as they provide adequate clearance for the free leg and the attachment 31 maintains adequate strength. The attachment 31 is illustrated in the figures as a rectangle having rounded corners, however, it is understood that the attachment could have other shapes without departing from the scope of the invention.

Additionally, the attachment 31 can be unhooked from the walker 11, turned over, and hooked back onto the walker so that the leg engagement portion 61 is located on the opposite side of the walker. In this configuration the top plate 35 would be located on the bottom and the bottom plate 37 would be located on the top. Because the plates 35, 37 mirror each other, the attachment 31 can be oriented in this manner. This allows the user to support either the right or left leg. The J-hooks 45 may be reversed in the slots 43 so they secure the support member 33 to the braces 25 in the same way as was described earlier.

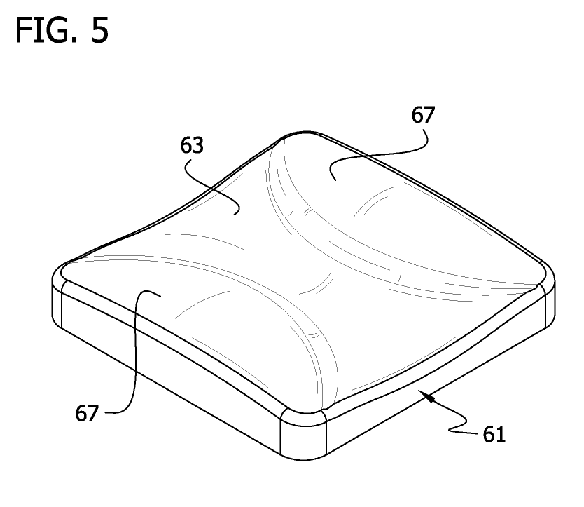

Referring to FIG. 5, the leg engagement portion 61 may also have a cushion 63 selectively engageable with the support member 33. The cushion is square having a pair of clips 65 formed on an underside of the cushion 63 and sized and shaped to clip the cushion onto hooks (not shown) on the support member 33. The cushion 63 also includes a saddle 67 on its top for receiving a knee of the leg of the user to cradle the leg and keep it in place against lateral movement. The cushion 63 is formed from of foam pad such as open cell foam, closed cell foam. However, it is contemplated that any suitable padded or foam-like material can be used without departing from the scope of the invention provided the material cushions the user's leg during use. Furthermore, the cushion 63 can be secured to the support member 33 by other means (ex., adhesive, Velcro fasteners, etc.) without departing from the scope of the invention.

In operation, the attachment 31 can be hooked onto the walker 11 by the J-hooks 45. The user can then rest the impaired leg on the saddle 67 of the cushion 63. The user begins walking by lifting the walker 11 at the gripping arms 23. Advancing the walker 11 is accomplished by moving the walker forward with the user's arms while keeping the knee of the impaired leg on the attachment 31. The saddle 67 of the cushion 63 stabilizes the knee against lateral sliding movement during this process, and throughout the use of the walker 11, without interfering with the movement of the knee with the walker. When the walker 11 is set down, the weight of the user is largely supported at the leg engagement portion 61 of the attachment 31 and the gripping arms 23. At this point, the swing phase of the free leg of the user begins. As the free leg swings toward the walker 11, the recess 63 provides sufficient clearance for the free leg to complete the swing phase of gait and contact the ground to begin another stride. It is also contemplated that a walker having wheels (thus the walker would not need to be lifted) could be used with the attachment without departing from the scope of the invention.

Allowing the user to rest their leg on the attachment 31 and move with the walker 11 positions the user's body in a more correct posture because the user is oriented substantially upright. This places the spine in more proper alignment for load bearing. Being able to advance the walker 11 with the impaired leg also reduces some of the stress on the user's back that could result from having to advance the walker completely with the upper body.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. An attachment adapted for use with a walker, the attachment comprising:
a support member having a longitudinal axis;
a leg engagement portion located on the support member; and
an opening in the support member extending transversely with respect to the longitudinal axis.

2. The attachment set forth in claim 1 wherein the opening is about least 8½ inches long and 3 inches wide.

3. The attachment set forth in claim 2 wherein the leg engagement portion includes a cushion having a saddle.

4. The attachment set forth in claim 3 wherein the cushion is selectively attachable to the support member.

5. The attachment set forth in claim 4 wherein the cushion is selectively attachable to a top and a bottom face of the support member.

6. The attachment set forth in claim 1 wherein the support member has top and bottom faces, the top face mirroring the bottom face.

7. An attachment adapted to engage a walker, the attachment comprising:
a support member having first and second ends and a leg engagement portion;
slots located on the first and second ends of the support member; and
hooks received through the slots and adapted to hook onto the walker, the hooks capable of sliding along the slots to adjust the position of the hooks in the slots.

8. The attachment set forth in claim 7 wherein the hooks are each separately adjustable along the slots.

9. The attachment set forth in claim 8 further comprising knobs secured to the ends of the hooks to lock the hooks in place.

10. The attachment set forth in claim 9 wherein the leg engagement portion comprises a cushion.

11. The attachment set forth in claim 10 further comprising an opening in the support member extending transversely with respect to the longitudinal axis.

12. The attachment set forth in claim 11 wherein the support member has top and bottom faces, the top face mirroring the bottom face.

13. The attachment set forth in claim 11 wherein the opening is about least 8½ inches long and 3 inches wide.

14. A walker comprising:
first and second front legs, first and second back legs, and first and second braces, the first brace connecting the first front leg to the first back leg and the second brace connecting the second front leg to the second back leg; and
an attachment comprising a support member, the support member having a longitudinal axis, first and second ends and a transverse opening, the attachment further comprising hooks associated with the first and second ends, the hooks being engaged with the first and second braces to hold the attachment between the first and second braces.

15. The walker set forth in claim 14 wherein the leg engagement portion includes a cushion having a saddle for receiving a knee.

16. A walker attachment comprising:
a support member having opposite top and bottom faces; and
a leg engagement portion selectively attachable to the top and bottom faces.

17. The walker attachment set forth in claim 16 further comprising an opening in the support member.

18. The walker attachment set forth in claim 17 wherein the leg engagement portion comprises a cushion.

19. The walker attachment set forth in claim 18 wherein the cushion includes a saddle for receiving a knee.
